(19) United States
(12) Patent Application Publication
(10) Pub. No.: US 2024/0030412 A1
(43) Pub. Date: Jan. 25, 2024

(54) Composite Pole Piece, Battery Cell and Preparation Method of Composite Pole Piece

(71) Applicant: JIANGSU ZENERGY BATTERY TECHNOLOGIES CO., LTD., Suzhou City (CN)

(72) Inventors: Hongjiang YU, Suzhou City (CN); Jicheng CHEN, Suzhou City (CN); Lei WEI, Suzhou City (CN); Rui WANG, Suzhou City (CN); Zhou XU, Suzhou City (CN)

(21) Appl. No.: 18/202,245

(22) Filed: May 25, 2023

(30) Foreign Application Priority Data
Jul. 22, 2022 (CN) 202210865561.2

(51) Int. Cl. H01M 4/36; H01M 4/66; H01M 4/583; H01M 4/04

(52) U.S. Cl. CPC H01M 4/366; H01M 4/668; H01M 4/661; H01M 4/583; H01M 4/0457; H01M 4/0435; H01M 2004/021

(57) ABSTRACT

The present disclosure relates to the technical field of batteries. Disclosed are a composite pole piece, a battery cell and a preparation method of the composite pole piece. The composite pole piece includes a supporting layer and an active composite layer. The supporting layer includes an insulating layer and a conductive layer arranged on a side of the insulating layer. The active composite layer is arranged on a side of the conductive layer far away from the insulating layer and includes an active layer and a metal foil layer. The active layer includes a plurality of active particles stacked on the conductive layer, and the metal foil layer is attached to the conductive layer and configured to fix the plurality of active particles on the conductive layer.

### CROSS-REFERENCE TO RELATED APPLICATION

The present disclosure claims priority to Chinese Patent Application No. 202210865561.2 filed to the China National Intellectual Property Administration on Jul. 22, 2022 and entitled “Composite Pole Piece, Battery Cell and Preparation Method of Composite Pole Piece”, the disclosure of which is hereby incorporated by reference in its entirety.

### TECHNICAL FIELD

The present disclosure relates to the technical field of batteries, and in particular to a composite pole piece, a battery cell and a preparation method of the composite pole piece.

### BACKGROUND

At present, in the field of power batteries and China Compulsory Certification (3C) batteries, the forming process of a pole piece is to coat an active substance of a positive or negative electrode on a current collector by coating. In order to improve the bonding effect of the active substance, an adhesive is usually added to the active substance so that the active substance is fixed on the current collector to form the pole piece. The amount of the adhesive may directly affect the adhesive force, and the adhesive force may not continue to increase after the adhesive is used to a certain extent. In order to ensure the adhesive force, there is a problem of high costs in increasing the amount of adhesive.

### SUMMARY

The present disclosure aims to provide a composite pole piece which fixes active particles in an active layer on a conductive layer through a metal foil layer, which can eliminate the use of adhesive and effectively reduce the production cost of the composite pole piece while ensuring the performance of the pole piece.

Another object of the present disclosure is to provide a battery cell including the composite pole piece above. Therefore, the costs are reduced while the performance is ensured.

Another object of the present disclosure is to provide a preparation method of the composite pole piece. During preparation, the composite pole piece which fixes the active particles in the active layer on the conductive layer through the metal foil layer may eliminate the use of adhesive and effectively reduce the production cost of the composite pole piece while ensuring the performance of the pole piece.

Some embodiments of the present disclosure are implemented as follows.

According to a first aspect, the present disclosure provides a composite pole piece, which includes a supporting layer and an active composite layer.

The supporting layer includes an insulating layer and a conductive layer arranged on a side of the insulating layer.

The active composite layer is arranged on a side of the conductive layer away from the insulating layer and includes an active layer and a metal foil layer. The active layer includes a plurality of active particles stacked on the conductive layer, and the metal foil layer is attached to the conductive layer and configured to fix the plurality of active particles on the conductive layer.

In an embodiment mode, a projection plane of the metal foil layer on the conductive layer in a direction perpendicular to the conductive layer is a first projection plane, and a projection plane of the active layer on the conductive layer in the direction perpendicular to the conductive layer is a second projection plane.

An area of the first projection plane is larger than an area of the second projection plane, and the second projection plane falls within a range of the first projection plane.

In an embodiment mode, in a width direction of the conductive layer, two sides of the metal foil layer are aligned with two sides of the conductive layer, and two sides of the active layer are aligned with the two sides of the conductive layer. In a length direction of the conductive layer, one end of two ends of the metal foil layer is aligned with a corresponding end of the conductive layer, and the other end of the two ends of the metal foil layer is at a first preset distance from the other corresponding end of the conductive layer; and one end of two ends of the active layer is aligned with the corresponding end of the conductive layer, and the other end of the two ends of the active layer is at a second preset distance from the corresponding end of the conductive layer.
Or,
in the length direction of the conductive layer, the two ends of the metal foil layer are aligned with the two ends of the conductive layer, and the two ends of the active layer are aligned with the two ends of the conductive layer. In the width direction of the conductive layer, a side of the two sides of the metal foil layer is aligned with a corresponding side of the conductive layer, and the other side of the two sides of the metal foil layer is at the first preset distance from the other corresponding side of the conductive layer; and one end of the two sides of the active layer is aligned with the corresponding side of the conductive layer, and the other side of the two sides of the active layer is at the second preset distance from the corresponding side of the conductive layer.

In an embodiment mode, the first preset distance is 0-1 mm; and/or the second preset distance is 5 mm-100 mm.

In an embodiment mode, a thickness of the supporting layer is 2 um-20 um.
And/or,
a thickness of the metal foil layer is 0.05 um-6 um.
And/or,
a thickness of the conductive layer is 1 nm-10 nm.
And/or,
the conductive layer includes a metal layer or a graphite layer.

In an embodiment mode, a material of the insulating layer is an organic polymer material or a ceramic-doped polymer.
Or,
the insulating layer is a polyethylene layer, a polypropylene layer or a PP/PE/PP composite layer.

In an embodiment mode, when the composite pole piece is a positive pole piece, the metal foil layer is a metal aluminum layer, and an active component in the active particles is lithium cobalt oxide, lithium iron phosphate, lithium manganate or lithium nickel cobalt manganate.

When the composite pole piece is a negative pole piece, the metal foil layer is a metal copper layer, and the active component in the active particles is graphite, hard carbon, soft carbon, lithium titanate or silicon carbon.

In an embodiment mode, a side of the active layer away from the conductive layer is provided with an active plane.

According to a second aspect, the present disclosure provides a battery cell. The battery cell includes a positive pole piece and a negative pole piece. At least one of the positive pole piece and the negative pole piece includes the composite pole piece according to any one of the above embodiment modes.

In an embodiment mode, the positive pole piece and the negative pole piece are both the composite pole pieces.

When thicknesses of the active composite layers of the positive pole piece and the negative pole piece are both less than a thickness of a corresponding supporting layer, the insulating layers of the positive pole piece and the negative pole piece are PE layers, PP layers or PP/PE/PP composite layers. The positive pole piece and the negative pole piece are sequentially stacked to form a bare battery cell, and the active composite layer of one of the positive pole piece and the negative pole piece is attached to the side, away from the conductive layer, of the insulating layer of the other.

When the thicknesses of the active composite layers of the positive pole piece and the negative pole piece are both greater than or equal to the thickness of the corresponding supporting layer, the bare battery cell further includes an isolation film arranged between the positive pole piece and the negative pole piece. The positive pole piece, the isolation film and the negative pole piece are sequentially stacked to form the bare battery cell; and the battery cell also includes a shell and an electrolyte, and the bare battery cell and the electrolyte are accommodated in the shell.

In an embodiment mode, the positive pole piece includes two composite pole pieces, and the sides, away from the active composite layer, of the two supporting layers of the two composite pole pieces are attached to each other; the negative pole piece includes two composite pole pieces, and the sides, away from the active composite layer, of the two supporting layers of the two composite pole pieces are attached to each other.

The bare battery cell further includes an isolation film, and the positive pole piece, the isolation film and the negative pole piece are sequentially stacked to form the bare battery cell; and the battery cell also includes a shell and an electrolyte, and the bare battery cell and the electrolyte are accommodated in the shell.

According to a third aspect, the present disclosure provides a preparation method of any composite pole piece in the above embodiment modes, which includes the following operations.

A plurality of active particles are stacked on the conductive layer to form an active layer.

Metal ions are deposited on a surface of the conductive layer from a side of the conductive layer close to the active layer to form the metal foil layer, and the plurality of active particles are fixed on the conductive layer during deposition.

In an embodiment mode, the step of stacking the plurality of active particles on the conductive layer to form the active layer specifically includes the following operation.

The supporting layer is placed in a colloidal solution containing the plurality of active particles for electrophoretic deposition, and the plurality of colloidal active particles are deposited on a side of the conductive layer away from the insulating layer to form the active layer.

In an embodiment mode, the step of electrophoretic deposition specifically includes the following operations.

The side of the insulating layer away from the conductive layer is attached to a first electrode plate and then put same into the colloidal solution.

A second electrode plate with a polarity opposite to that of the first electrode plate is put into the colloidal solution and arranged at an interval from the first electrode plate.

The first electrode plate and the second electrode plate are electrified.

In an embodiment mode, a distance that a circumferential direction of the first electrode plate exceeds a circumferential direction of the insulating layer is 5 mm-100 mm.
And/or,
an area of each of the first electrode plate and the second electrode plate is 0.001 m²-200 m².
And/or,
a distance between the first electrode plate and the second electrode plate is 5 mm-5 m.

In an embodiment mode, the colloidal solution has a pH of 7-10.

In an embodiment mode, after the insulating layer is put into the colloidal solution, the insulating layer exceeds a liquid level of the colloidal solution by 5 mm-100 mm.

In an embodiment mode, before the supporting layer is placed in the colloidal solution, the following operation is further included.

The active particles are dispersed in an organic solvent, and stirred to obtain the colloidal solution containing the colloidal active particles.

In an embodiment mode, in the process of stirring to obtain the colloidal solution, a stirring speed is 5 rmp-2000 rpm and a stirring time is 30 min-300 min.

In an embodiment mode, the step of depositing the metal ions on the surface of the conductive layer from the side of the conductive layer close to the active layer to form the metal foil layer specifically includes the following operations.

The supporting layer with the active particles stacked is placed in an ionic solution containing the metal ions for electrodeposition, so as to form the metal foil layer by deposition on the surface of the conductive layer.

When the composite pole piece is a negative pole piece, the ionic solution is a copper ionic solution, and a concentration of the copper ionic solution is 0.001 mol/L-0.1 mol/L. When the composite pole piece is a positive pole piece, the ionic solution is an aluminum ionic solution, and a concentration of the aluminum ionic solution is 0.001 mol/L-0.1 mol/L.

In an embodiment mode, in the electrodeposition step, a deposition thickness of the metal foil layer is 0.05 um-6 um, and the deposition thickness of the metal foil layer is adjusted according to the following rules.

When a deposition temperature is 45° C., a deposition current is 100 A, a concentration of the ionic solution is 0.01 mol/L, a deposition time is 2 min, and a deposition area is 50 mm×100 mm, a deposition thickness is 23.1 um.

When the deposition temperature is 45° C., the deposition current is 100 A, the concentration of the ionic solution is 0.01 mol/L, the deposition time is 1 min, and the deposition area is 50 mm×50 mm, the deposition thickness is 22.8 um.

When the deposition temperature is 45° C., the deposition current is 50 A, the concentration of the ionic solution is 0.02 mol/L, the deposition time is 1 min, and the deposition area is 50 mm×100 mm, the deposition thickness is 20.7 um.

When the deposition temperature is 45° C., the deposition current is 100 A, the concentration of the ionic solution is 0.01 mol/L, the deposition time is 1 min, and the deposition area is 50 mm×100 mm, the deposition thickness is 12.7 um.

When the deposition temperature is 35° C., the deposition current is 100 A, the concentration of the ionic solution is 0.01 mol/L, the deposition time is 1 min, and the deposition area is 50 mm×100 mm, the deposition thickness is 11.3 um.

When the deposition temperature is 45° C., the deposition current is 100 A, the concentration of the ionic solution is 0.01 mol/L, the deposition time is 1 min, and the deposition area is 50 mm×100 mm, the deposition thickness is 6.5 um.

When the deposition temperature is 45° C., the deposition current is 30 A, the concentration of the ionic solution is 0.01 mol/L, the deposition time is 1 min, and the deposition area is 50 mm×100 mm, the deposition thickness is 4.8 um.

When the deposition temperature is 45° C., the deposition current is 25 A, the concentration of the ionic solution is 0.02 mol/L, the deposition time is 1 min, and the deposition area is 50 mm×100 mm, the deposition thickness is 4.1 um.

When the deposition temperature is 45° C., the deposition current is 20 A, the concentration of the ionic solution is 0.01 mol/L, the deposition time is 1 min, and the deposition area is 50 mm×100 mm, the deposition thickness is 3.2 um.

In an embodiment mode, in the electrodeposition step,
the insulating layer exceeds a liquid level of the ionic solution by 0-1 mm.

In an embodiment mode, before the plurality of active particles are stacked on the conductive layer, an operation of spraying, coating or depositing a conductive substance on a side of the insulating layer to form the conductive layer on the insulating layer is further included.

In an embodiment mode, after the metal foil layer is formed by deposition on the surface of the conductive layer, an operation of performing rolling operation is further included to enable the active layer to press against the conductive layer and enable a side of the active layer away from the conductive layer to form an active plane.

In an embodiment mode, a rolling pressure of the rolling operation is 5 T-500 T, and a rolling temperature is 50° C.-90° C.

The embodiments of the present disclosure have the following advantages or beneficial effects.

The embodiments of the present disclosure provide the composite pole piece, which includes a supporting layer and an active composite layer. The supporting layer includes the insulating layer and the conductive layer arranged on a side of the insulating layer. The active composite layer is arranged on a side of the conductive layer far away from the insulating layer and includes the active layer and the metal foil layer. The active layer includes the plurality of active particles stacked on the conductive layer, and the metal foil layer is attached to the conductive layer and configured to fix the plurality of active particles on the conductive layer. On the one hand, the conductive layer is arranged, and the plurality of active particles in the active layer are stacked on the conductive layer using the characteristic of active electric conductivity of electrons near the conductive layer, so that the metal foil layer is attached to the conductive layer, and the performance and quality of the composite pole piece are guaranteed. On the other hand, the metal foil layer fixes the active particles in the active layer on the conductive layer, which eliminates the use of adhesive during preparation and effectively reduces the production cost of the composite pole piece.

The embodiments of the present disclosure further provide a battery cell, which includes the composite pole piece above. Therefore, the costs are reduced while the performance is ensured.

The embodiments of the present disclosure further provide a preparation method of the composite pole piece. On the one hand, during preparation, the conductive layer is arranged, and the plurality of active particles in the active layer are stacked on the conductive layer using the characteristic of active electric conductivity of the electrons near the conductive layer, so that the metal foil layer is attached to the conductive layer, and the performance and quality of the composite pole piece are guaranteed. On the other hand, in the method, the active particles in the active layer are fixed on the conductive layer during deposition of the metal foil layer, which eliminates the use of adhesive and effectively reduces the production cost of the composite pole piece.

### BRIEF DESCRIPTION OF THE DRAWINGS

In order to more clearly explain the technical solutions of the embodiments of the present disclosure, the drawings used in the embodiments will be briefly introduced below. It is to be understood that the following drawings only illustrate some embodiments of the present disclosure, which therefore should not be regarded as limitations to the scope. For those of ordinary skill in the art, other related drawings may also be obtained in accordance with these drawings without creative efforts.

FIG. 1 is a schematic structural diagram I of a composite pole piece according to an embodiment of the present disclosure.

FIG. 2 is a schematic structural diagram II of a composite pole piece according to an embodiment of the present disclosure.

FIG. 3 is a schematic flowchart of preparation of a composite pole piece according to an embodiment of the present disclosure.

FIG. 4 is a structural diagram of forming an active layer by electrophoretic deposition according to an embodiment of the present disclosure.

FIG. 5 is a partial enlarged diagram of part I in FIG. 4.

FIG. 6 is a structural stereogram of a semi-finished product of a composite pole piece after an electrophoretic deposition step according to an embodiment of the present disclosure.

FIG. 7 is a structural diagram of forming a metal foil layer by electrodeposition according to an embodiment of the present disclosure.

FIG. 8 is a partial enlarged diagram of part II in FIG. 7.

FIG. 9 is a schematic structural diagram of a semi-finished product of a composite pole piece after an electrodeposition step according to an embodiment of the present disclosure.

FIG. 10 is a schematic structural diagram of a finished product of a composite pole piece after a rolling step according to an embodiment of the present disclosure.

FIG. 11 is a schematic structural diagram of a first type of bare battery cell according to an embodiment of the present disclosure.

FIG. 12 is a schematic structural diagram of a second type of bare battery cell according to an embodiment of the present disclosure.

FIG. 13 is a schematic structural diagram of a third type of bare battery cell according to an embodiment of the present disclosure.

FIG. 14 is a schematic diagram of a nail threading test on a battery cell according to a related art.

FIG. 15 is a result diagram of a nail threading test on a battery cell according to the related art.

FIG. 16 is a schematic diagram of a nail threading test of a battery cell formed after housing a first type of bare battery cell according to an embodiment of the present disclosure.

FIG. 17 is a result diagram of a nail threading test of a battery cell formed after housing a first type of bare battery cell according to an embodiment of the present disclosure.

Icons: 10, composite pole piece; 11, supporting layer; 12, active composite layer; 15, isolation film; 101, insulating layer; 102, conductive layer; 103, active layer; 104, metal foil layer; 106, active particle; 107, active plane; 109, first electrode plate; 111, second electrode plate; 113, metal ion; 115, colloidal solution; 117, ionic solution; 119, third electrode plate; and 121, fourth electrode plate.

### DETAILED DESCRIPTION OF THE EMBODIMENTS

In order to make the purposes, technical solutions and advantages of the embodiments of the present disclosure clearer, the technical solutions in the embodiments of the present disclosure will be clearly and completely described below in combination with the drawings in the embodiments of the present disclosure, and it is apparent that the described embodiments are only a part rather all of embodiments of the present disclosure. Components of the embodiments of the present disclosure generally described and illustrated here in the drawings may be arranged and designed in various different configurations.

Therefore, the following detailed descriptions of the embodiments of the present disclosure provided in the drawings are not intended to limit the scope of the claimed present disclosure, but only represent selected embodiments of the present disclosure. All other embodiments obtained by those of ordinary skill in the art on the basis of the embodiments in the present disclosure without creative work shall fall within the scope of protection of the present disclosure.

It is to be noted that similar numbers and letters indicate similar items in the following drawings, so once a certain item is defined in one drawing, no further definitions and explanations are required for same in the subsequent drawings.

In the descriptions of the present disclosure, it is to be noted that the orientation or location relationships indicated by the terms “center”, “upper”, “lower”, “left”, “right”, “vertical”, “horizontal”, “inner” and “outer” are orientation or location relationships shown on the basis of the drawings, or the usual orientation or location relationship of the product when in use, which are only for the convenience of describing the present disclosure and simplifying the descriptions, rather than indicating or implying that the referred apparatuses or elements must have a specific orientation, and be constructed and operated in the specific orientation. Therefore, it cannot be understood as a limitation of the present disclosure. In addition, terms “first”, “second” and “third” are only used for describing purposes, and cannot be understood as indicating or implying relative importance.

In addition, if terms “horizontal” and “vertical” appears, it does not mean that components are required to be absolutely horizontal or suspended, but may be slightly inclined. For example, “horizontal” only means that its direction is more horizontal than “vertical”, which does not mean that the structure must be completely horizontal, but may be slightly inclined.

In the descriptions of the present disclosure, it is also to be noted that, unless otherwise specified and defined, terms “setting”, “mounting”, “mutual connection”, and “connection” should be generally understood. For example, the term may be fixed connection, or detachable connection, or integral connection, or mechanical connection, or electric connection. The term may be direct connection, or indirect connection through an intermediate, or communication inside two elements. Those of ordinary skill in the art may understand the specific meanings of the terms in the present disclosure according to specific conditions.

In a related art, the forming process of a pole piece is to coat an active substance of a positive or negative electrode on a current collector by coating. In order to improve the bonding effect of the active substance, an adhesive is usually added to the active substance so that the active substance may be fixed on the current collector to form the pole piece. The amount of the adhesive may directly affect the adhesive force, and the adhesive force may not continue to increase after the adhesive is used to a certain extent. In order to ensure the adhesive force, there is a problem of high costs in increasing the amount of adhesive.

In view of this, the embodiment provides a composite pole piece which fixes active particles in an active layer on a conductive layer through a metal foil layer, which may eliminate the use of adhesive and effectively reduce the production cost of the composite pole piece while ensuring the performance of the pole piece. Detailed introductions are made below to the composite pole piece, a preparation method thereof and a battery cell formed by the composite pole piece.

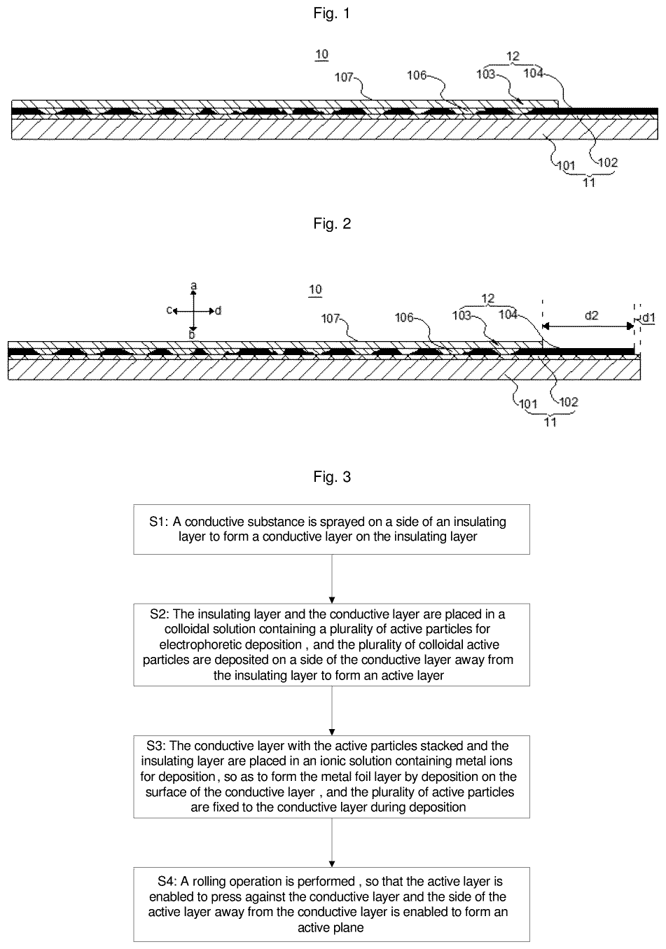

FIG. 1 is a schematic structural diagram I of a composite pole piece 10 according to an embodiment of the present disclosure. FIG. 2 is a schematic structural diagram II of a composite pole piece 10 according to an embodiment of the present disclosure. Referring to FIGS. 1 and 2, the composite pole piece 10 provided in the embodiment includes a supporting layer 11 and an active composite layer 12.

The supporting layer 11 is a base structure of the composite pole piece 10 and includes an insulating layer 101 and a conductive layer 102 arranged on a side of the insulating layer 101. The insulating layer 101 is configured to provide insulation and support functions and ensure the strength of the pole piece. The conductive layer 102 is a nano-level conductive substance layer formed by spraying, coating or depositing a conductive substance (such as conductive particles such as graphite and conductive metal ions) on the insulating layer 101. After the conductive layer 102 is arranged on a side of the insulating layer 101, the electric conductivity of electrons near this side of the insulating layer 101 is improved, which is able to facilitate the preparation of the active composite layer 12 on the conductive layer 102 in a subsequent preparation process.

Exemplarily, in the embodiment, the conductive layer 102 is sprayed on a surface of the insulating layer 101, and a graphite layer such as graphene is selected as the conductive layer 102, and a thickness of the conductive layer 102 is selected to be 1 nm-10 nm, and specifically 5 nm. The conductive layer 102 is arranged on a side of the insulating layer 101 in a full-coverage form, so as to ensure the uniformity of the electric conductivity of the electrons at various positions on this side of the insulating layer 101 and ensure the performance of the prepared composite pole piece 10.

The active composite layer 12 is an active substance source of the composite pole piece 10, which is able to ensure that the pole piece has positive or negative active performance, so as to be wound or laminated to form a high-performance battery cell. Specifically, the active composite layer 12 is arranged on a side of the conductive layer 102 away from the insulating layer 101. The active composite layer 12 includes an active layer 103 and a metal foil layer 104. The active layer 103 includes a plurality of active particles 106 stacked on the conductive layer 102, and the metal foil layer 104 is attached to the conductive layer 102 and configured to fix the plurality of active particles 106 on the conductive layer 102. Through such an arrangement, each active particle 106 in the active layer 103 is in contact with the conductive layer 102, and at the same time, the active particle 106 is in contact with the metal foil layer 104. Moreover, the metal foil layer 104 is also in contact with the active particle 106 and the conductive layer 102 at the same time, and is attached to the conductive layer 102 for fixing the active particle 106.

On the one hand, the conductive layer 102 is arranged, and the plurality of active particles 106 in the active layer 103 are stacked on the conductive layer 102 using the characteristic of active electric conductivity of the electrons near the conductive layer 102, so that the metal foil layer 104 is attached to the conductive layer 102, and the performance and quality of the composite pole piece are guaranteed. On the other hand, the metal foil layer 104 fixes the active particles 106 in the active layer 103 on the conductive layer 102, which eliminates the use of adhesive during preparation and effectively reduces the production cost of the composite pole piece 10.

It is to be noted that materials selected for each layer of the active composite layer 12 in the composite pole piece 10 are all different according to the polarity of the composite pole piece 10. Exemplarily, when the composite pole piece 10 serves as a positive pole piece, the metal foil layer is a metal aluminum layer, and an active component in the active particles 106 is lithium cobalt oxide, lithium iron phosphate, lithium manganate or lithium nickel cobalt manganate. When the composite pole piece 10 serves as a negative pole piece, the metal foil layer 104 is a metal copper layer, and the active component in the active particles 106 is graphite, hard carbon, soft carbon, lithium titanate or silicon carbon.

It is also to be noted that an exposed surface of the active layer 103, that is, the side of the active layer 103 away from the conductive layer 102, is provided with an active plane 107 since the composite pole piece 10 needs to be wound or laminated to form a bare battery cell in the subsequent preparation process. The plane structure facilitates winding or laminating, and may also reduce the damage to an adjacent pole piece and ensure the safety performance of the bare battery cell and the battery cell.

Referring to FIGS. 1 and 2 again, in the embodiment, a projection plane of the metal foil layer 104 on the conductive layer 102 in a direction (being the thickness direction of the composite pole piece 10 and also being an ab direction in FIG. 2) perpendicular to the conductive layer 102 is a first projection plane. A projection plane of the active layer 103 on the conductive layer 102 in the direction perpendicular to the conductive layer 102 is a second projection plane. An area of the first projection plane is larger than an area of the second projection plane, and the second projection plane falls within a range of the first projection plane. Through such an arrangement, a circumferential direction of the metal foil layer 104 is beyond a circumferential direction of the active layer 103, and an excess part is directly processed (exemplarily, the processing manner is able to be selected as cutting, and in other embodiments, the pole piece is able to be directly formed without cutting) to form a positive tab or a negative tab, so as to be electrically connected with a positive column or a negative column of the battery cell.

Exemplarily, referring to FIG. 2 once again, in order to facilitate processing the battery tab, in the embodiment, in the width direction (a direction perpendicular to a paper plane in FIG. 2) of the conductive layer 102, two sides of the metal foil layer 104 are aligned with two sides of the conductive layer 102, and two sides of the active layer 103 are aligned with the two sides of the conductive layer 102. In the length direction (a cd direction in FIG. 2) of the conductive layer 102, one end of two ends of the metal foil layer 104 is aligned with a corresponding end of the conductive layer 102, and the other end of the two ends of the metal foil layer 104 is at a first preset distance d1 from the other corresponding end of the conductive layer 102; and one end of two ends of the active layer 103 is aligned with the corresponding end of the conductive layer 102, and the other end of the two ends of the active layer 103 is at a second preset distance d2 from the corresponding end of the conductive layer 102. The first preset distance is 0-1 mm. When the first preset distance is 0 mm, in FIG. 2 as shown by the structure in FIG. 1, the metal foil layer 104 completely covers the conductive layer 102. Exemplarily, the first preset distance is able to be selected as 0.5 mm. The second preset distance is 5 mm-100 mm. Exemplarily, the second preset distance is 50 mm.

Since a cut part of the battery tab cannot be coated with the active substance, the battery tab is cut and formed conveniently by setting the first preset distance and the second preset distance, so that the length of the processed battery tab is ensured, the convenience of processing and forming the battery tab are ensured, the preparation efficiency and quality are improved, and the costs are saved.

It is to be noted that in other embodiments, it also is set that in the length direction of the conductive layer 102, the two ends of the metal foil layer 104 are aligned with the two ends of the conductive layer 102, and the two ends of the active layer 103 are aligned with the two ends of the conductive layer 102. In the width direction of the conductive layer 102, a side of the two sides of the metal foil layer 104 is aligned with a corresponding side of the conductive layer 102, and the other side of the two sides of the metal foil layer 104 is at the first preset distance from the other corresponding side of the conductive layer 102; and one end of the two sides of the active layer 103 is aligned with the corresponding side of the conductive layer 102, and the other side of the two sides of the active layer 103 is at the second preset distance from the corresponding side of the conductive layer 102, which is not repeated in the embodiment.

It is also to be noted that in the embodiment, the thickness of the metal foil layer 104 is related to the ability to fix the active particle 106 on the one hand, and related to the performance of the composite pole piece 10 on the other hand. Therefore, in the embodiment, the thickness of the metal foil layer 104 is specifically selected to be 0.05 um-6 um. Exemplarily, the thickness may be selected to be 4.8 um, so as to save the costs and ensure the performance of the pole piece. Of course, in other embodiments, the thickness of the metal foil layer 104 is adjusted according to the costs and demand, which is not limited in the embodiment.

Further detailed introduction is made below to the preparation process and structure of the composite pole piece 10 in conjunction with a preparation method of the composite pole piece 10.

FIG. 3 is a schematic flowchart of preparation of a composite pole piece 10 according to the embodiment. The embodiment of the present disclosure further provides a preparation method of the composite pole piece 10, which includes the following steps.
At S1, a conductive substance is sprayed on a side of the insulating layer 101 to form a conductive layer 102 on the insulating layer 101.
At S2, the insulating layer 101 and the conductive layer 102 are placed in a colloidal solution 115 containing the plurality of active particles 106 for electrophoretic deposition, and the plurality of colloidal active particles 106 are deposited on the side of the conductive layer 102 away from the insulating layer 101 to form an active layer 103.
At S3, the conductive layer 102 with the active particles 106 stacked and the insulating layer 101 are placed in an ionic solution 117 containing metal ions 113 for deposition, so as to form the metal foil layer 104 by deposition on the surface of the conductive layer 102, and the plurality of active particles 106 are fixed to the conductive layer 102 during deposition.
At S4, a rolling operation is performed, so that the active layer 103 is enabled to press against the conductive layer 102 and the side of the active layer 103 away from the conductive layer 102 is enabled to form an active plane 107.

In detail, in S1, the conductive substance is graphite, which is specifically sprayed on the insulating layer 101 by spraying, and the spraying thickness is 1 nm-10 nm, and is specifically selected to be 5 nm. Of course, in the embodiment, S1 may also be omitted. When S1 is omitted, it means that it is not necessary to prepare the supporting layer 11 first. At this time, the insulating layer 101 provided with the conductive layer 102 may be directly used to prepare the composite pole piece 10, which is not repeated in the embodiment.

In S2, the main purpose is to stack the plurality of active particles 106 on the conductive layer 102 to form the active layer 103. The specific manner adopted in the embodiment is electrophoretic deposition, but it does not mean that electrophoretic deposition is the only preparation method. In other embodiments, the active layer 103 also is formed by vapor deposition when the costs and conditions permit, which is not repeated in the embodiment.

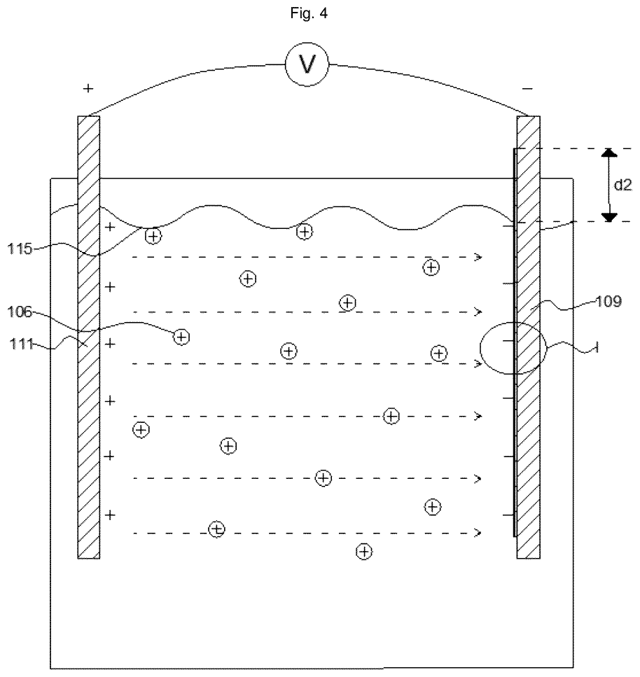

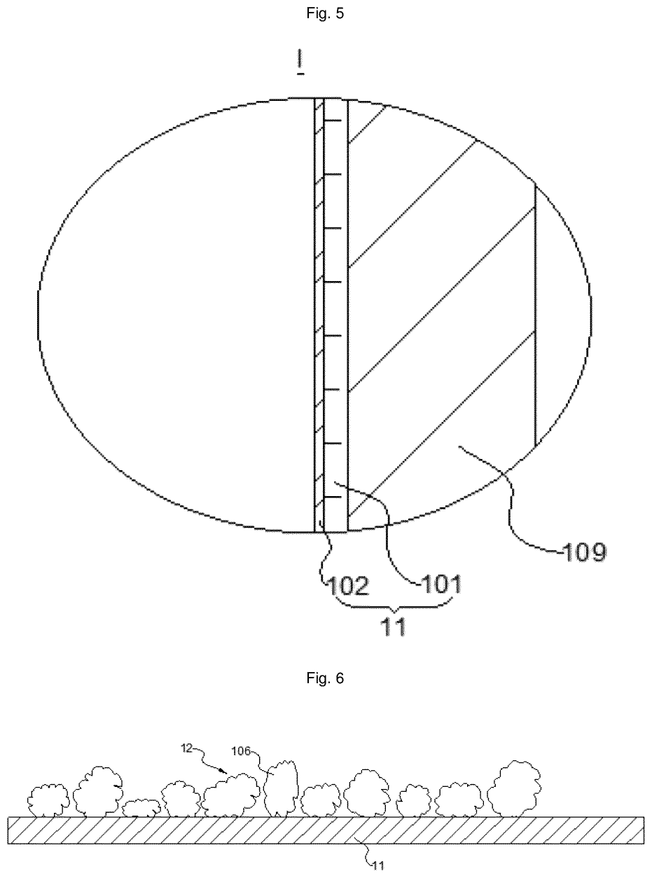

Specifically, FIG. 4 is a structural diagram of forming the active layer 103 by electrophoretic deposition according to the embodiment. FIG. 5 is a partial enlarged diagram of part I in FIG. 4. FIG. 6 is a structural stereogram of a semi-finished product of the composite pole piece 10 after an electrophoretic deposition step according to the embodiment. Referring to FIGS. 4 to 6, in the embodiment, S2 specifically includes that at S21, the side of the insulating layer 101 away from the conductive layer 102 is attached to a first electrode plate 109 and then put into a colloidal solution 115; at S22, a second electrode plate 111 with a polarity opposite to that of the first electrode plate 109 is put into the colloidal solution 115 and arranged at an interval from the first electrode plate 109; and at S23, the first electrode plate 109 and the second electrode plate 111 are electrified. The order of S21 and S22 may be reversed, the first electrode plate 109 and the second electrode plate 111 are the basis of the electrophoretic deposition operation, and the polarities of the two are opposite. The purpose of electrophoretic deposition is a process of depositing the colloidal active particles 106 on the surface of the conductive layer 102 in an electrified environment to form the active layer 103 under the action of a direct-current electric field in a stable suspension. In this process, the active particles 106 of a positive electrode or a negative electrode exist in a form of colloidal particles, which are insoluble in a solvent and form colloidal charged particles in the solvent. Therefore, an organic solvent such as ethanol may be specifically selected as the solvent. Compared with a corrosive and expensive oil-based solvent (such as NMP) used in the related art to prepare the pole piece, the organic solvent such as ethanol is adopted in the embodiment, which is low in material cost, non-corrosive and environmentally friendly and pollution-free on the one hand. On the other hand, the active particles 106 are insoluble in the organic solvent and can form the colloidal active particles 106, thus facilitating being stacked on the surface of the conductive layer 102 during electrophoretic deposition, to ensure the reliability of preparation of the composite pole piece 10. In other embodiments, the type of the organic solvent is adjusted according to requirements, and the organic solvent such as non-toxic alcohol or ether is preferred, which is not limited in the embodiment.

It is to be noted that in the embodiment, the colloidal solution 115 has a pH of 7-10, the solubility of the active particles 106 is lower in a weakly alkaline environment, and it is more difficult to dissolve in the organic solvent such as ethanol, so that the preparation operation is ensured to perform effectively. In addition, in the electrophoretic deposition operation, the prepared colloidal solution 115 is directly used, or the colloidal solution 115 is prepared first. When the colloidal solution 115 is prepared, the active particles 106 are dispersed in ethanol and stirred to obtain the colloidal solution 115 containing the colloidal active particles 106. A stirring speed is 5 rmp-2000 rpm and a stirring time is 30 min-300 min. The faster the stirring speed is, the shorter the stirring time is and the higher the efficiency is.

More specifically, in the embodiment, in the electrophoretic deposition process, the direct-current electric field of 2-200V is applied to the colloidal solution 115, and the areas of the first electrode plate 109 and the second electrode plate 111 are 0.001 m²-200 m². Exemplarily, the first electrode plate 109 and the second electrode plate 111 of 100 cm×100 cm are used in the embodiment. The circumferential direction of the first electrode plate 109 exceeds the circumferential direction of the insulating layer 101 by 5 mm-100 mm. Exemplarily, the circumferential direction is selected to exceed 30 mm, and the distance between the first electrode plate 109 and the second electrode plate 111 is 5 mm-5 m, and exemplarily, may be selected to be 2.5 m. Since the current density at the edges of the first electrode plate 109 and the second electrode plate 111 is usually distributed unevenly, which affects the uniformity of the deposited active layer 103. Therefore, in the embodiment, the uniformity of the deposited active layer 103 is improved by setting the circumferential direction of the first electrode plate 109 beyond the circumferential direction of the insulating layer 101. As shown in FIGS. 4 and 5, after electrification, the direct-current electric field is formed between the first electrode plate 109 and the second electrode plate 111, and the charged colloidal active particles 106 is able to move toward the first electrode plate 109 under the action of electric field force to deposit on the surface of the conductive layer 102 to form the active layer 103.

Exemplarily, in order to facilitate the cutting of the battery tab, after the insulating layer 101 is put into the colloidal solution 115 during the electrophoretic deposition operation, the insulating layer 101 exceeds a liquid level of the colloidal solution 115 by 5 mm-100 mm (that is, d2), for example, 50 mm. Through such an arrangement, the prepared composite pole piece 10 has a distance d2 as shown in FIG. 2, thus facilitating processing the battery tab, saving costs and improving the preparation efficiency.

It is to be noted that in the process of preparing the composite pole piece 10, the selected materials and the polarities of the first electrode plate 109 and the second electrode plate 111 arranged is adjusted according to the different polarities of the composite pole piece 10 to be prepared. Exemplarily, when the composite pole piece 10 serves as a positive pole piece, the active component in the active particles 106 is lithium cobalt oxide, lithium iron phosphate, lithium manganate or lithium nickel cobalt manganate. During preparation, the polarity of the first electrode plate 109 is positive. When the composite pole piece 10 serves as a negative pole piece, the active component in the active particles 106 is graphite, hard carbon, soft carbon, lithium titanate or silicon carbon, and the polarity of the first electrode plate 109 is selected to be negative.

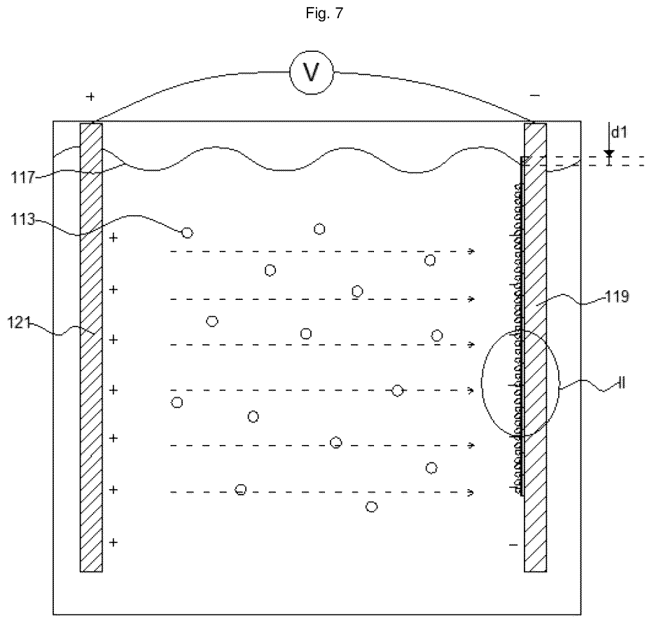

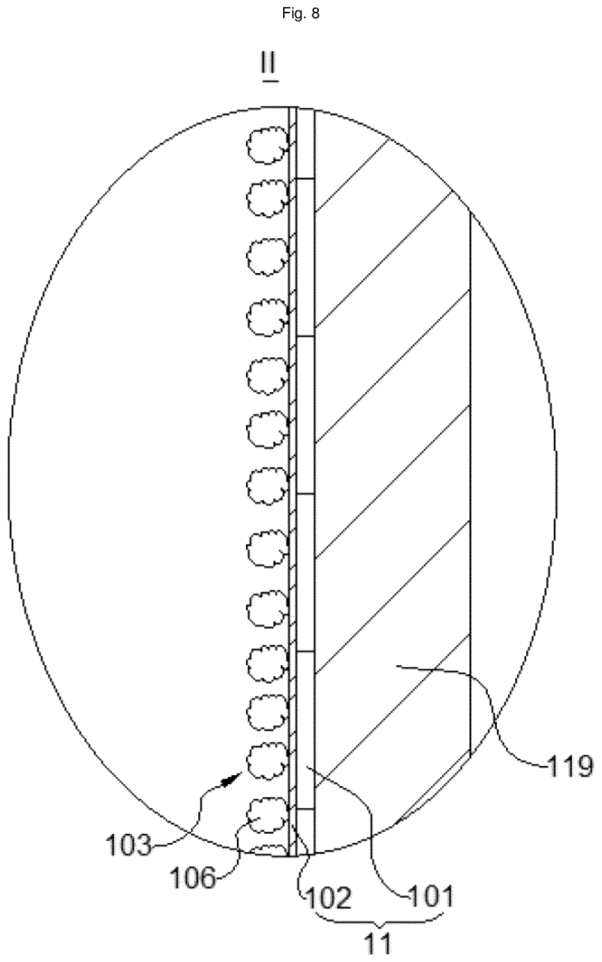

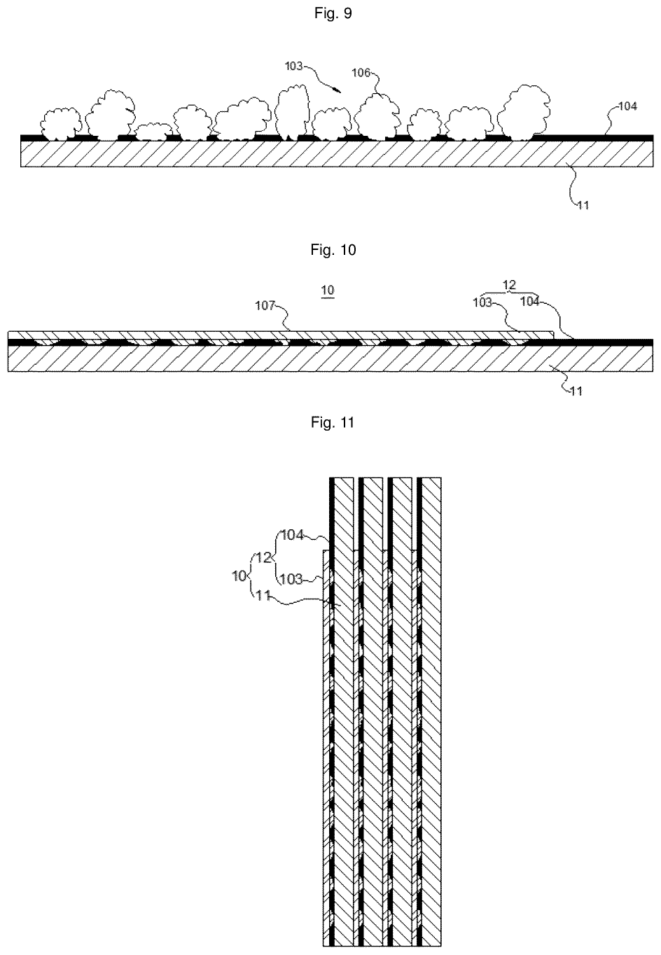

FIG. 7 is a structural diagram of forming the metal foil layer 104 by electrodeposition according to the embodiment. FIG. 8 is a partial enlarged diagram of part II in FIG. 7. FIG. 9 is a schematic structural diagram of a semi-finished product of the composite pole piece 10 after an electrodeposition step according to the embodiment. Referring to FIGS. 7 to 9, in S3, the main purpose is to stack the metal ions 113 on the surface of the conductive layer 102 from a side of the conductive layer 102 close to the active layer 103 to form the metal foil layer 104, and the plurality of active particles 106 are fixed to the conductive layer 102 during deposition. The specific manner adopted in the embodiment is electrodeposition such as electroplating, but it does not mean that electroplating is the only preparation method. In other embodiments, the metal foil layer 104 may also be formed by vapor deposition when the costs and conditions permit, which is not repeated in the embodiment.

In S3, electrodeposition refers to a process of electrochemical deposition of the metal ions 113 from a compound aqueous solution, non-aqueous solution or molten salt. Unlike the electrophoretic deposition of the active particles 106, electrodeposition refers to the deposition process of the metal ions 113 on the electrode surface in the solution. Since the adhesion between the active particles 106 of the active layer 103 formed by electrophoretic deposition mainly depends on intermolecular force, the adhesion force is not strong, and there is a case of falling off, which does not facilitate subsequent processing and molding of the composite pole piece 10. Therefore, in the embodiment, the metal foil layer 104 is electrodeposited, so that the bonding strength between the active layer 103 and the conductive layer 102 is effectively improved to ensure the quality of the composite pole piece 10. At the same time, since the conductive layer 102 is arranged on the surface of the insulating layer 101 and the surface conductive activity of the conductive layer 102 is greater than the conductivity activity of the active layer 103, so that the metal ions 113 is able to bypass the active particles 106 of the active layer 103 and be deposited on the surface of the conductive layer 102 during electrodeposition. That is exactly why the plurality of active particles 106 are fixed on the surface of the conductive layer 102 during deposition, so as to avoid using an adhesive, thus effectively saving costs.

It is to be noted that in the embodiment, the electrode plate is also required for electrodeposition. As shown in FIG. 7, a third electrode plate 119 and a fourth electrode plate 121 are required for electrodeposition, and both the third electrode plate 119 and the fourth electrode plate 121 are placed in an ionic solution 117 containing the metal ions 113, so as to facilitate the electrodeposition operation after being electrified. The supporting layer 11 is specifically attached to the third electrode plate 119, and the active layer 103 faces the fourth electrode plate 121. When the positive pole piece is prepared, the polarity of the third electrode plate 119 is positive, and when the negative pole piece is prepared, the polarity of the third electrode plate 119 is negative.

In addition, depending on the polarity of the composite pole piece 10, the types of the ionic solution 117 are different. For example, when the composite pole piece 10 is the negative pole piece, the ionic solution 117 is a copper ionic solution, and the concentration of the copper ionic solution is selected to be 0.001 mol/L-0.1 mol/L, and exemplarily, may be selected to be 0.01 mol/L. At this time, the metal foil layer 104 formed by electrodeposition is a copper foil layer. Similarly, when the composite pole piece 10 is the positive pole piece, the ionic solution 117 is an aluminum ionic solution, and the concentration of the aluminum ionic solution is selected to be 0.001 mol/L-0.1 mol/L, and exemplarily, may be selected to be 0.01 mol/L. At this time, the metal foil layer 104 formed by electrodeposition is an aluminum foil layer.

It is also to be noted that in the embodiment, the deposition thickness of the metal foil layer 104 directly affects the costs of the composite pole piece 10, the connection strength between the active layer 103 and the conductive layer 102, and the connection strength between the metal foil layer 104 and the conductive layer 102 during electrodeposition. Therefore, in the embodiment, the deposition thickness of the metal foil layer 104 is 0.05 um-6 um and is selected to be 4.8 um in the embodiment, and the deposition thickness of the metal foil layer 104 is adjusted through a rule in the following Table 1, so as to save the costs and time.

TABLE 1
Rule of thickness of the metal foil layer 104

| Ambient | Deposition | Solution ion | Deposition | | Deposition | |
|---|---|---|---|---|---|---|
| temperature | current | concentration | time | Deposition area | thickness | |
| 45° C. | 100A | 0.01 mol/L | 2 min | 50 mm × 100 mm | 23.1 | um |
| 45° C. | 100A | 0.01 mol/L | 1 min | 50 mm × 50 mm | 22.8 | um |
| 45° C. | 100A | 0.02 mol/L | 1 min | 50 mm × 100 mm | 20.7 | um |
| 45° C. | 100A | 0.01 mol/L | 1 min | 50 mm × 100 mm | 12.7 | um |
| 35° C. | 100A | 0.01 mol/L | 1 min | 50 mm × 100 mm | 11.3 | um |
| 45° C. | 50A | 0.01 mol/L | 1 min | 50 mm × 100 mm | 6.5 | um |
| 45° C. | 30A | 0.01 mol/L | 1 min | 50 mm × 100 mm | 4.8 | um |
| 45° C. | 25A | 0.02 mol/L | 1 min | 50 mm × 100 mm | 4.1 | um |
| 45° C. | 20A | 0.01 mol/L | 1 min | 50 mm × 100 mm | 3.2 | um |

According to the rule in the Table 1, the parameters are adjusted according to the required thickness during deposition to improve the deposition efficiency and quality, so as to obtain the metal foil layer 104 with the required thickness.

As an optional solution, in order to facilitate the processing of the battery tab, in the embodiment, the insulating layer 101 exceeds a liquid level of the ionic solution 117 by 0-1 mm, and 0.5 mm is selected in the embodiment. In other embodiments, 0 or 1 or another numerical value also is selected. Through such an arrangement, the area of the metal foil layer 104 is ensured to be larger than an area of the active layer 103, so that the processing of the battery tab is facilitated.

FIG. 10 is a schematic structural diagram of a finished product of the composite pole piece 10 after a rolling step according to the embodiment. Referring to FIG. 10, in S4 of the embodiment, the rolling operation is either cold pressing or hot pressing. A rolling pressure of the rolling operation is 5 T-500 T, for example, 250 T, and a rolling temperature is 50° C.-90° C., for example, 60° C. Through the selection and setting of the parameters, the active layer 103 is pressed against the conductive layer 102, the side of the active layer 103 away from the conductive layer 102 forms the active plane 107, and the thickness of the active layer 103 is reduced, so that the thickness of the active layer 103 is similar to the thickness of the metal foil layer 104, reaching 0.05 um-6 um, thus facilitating subsequent manufacturing of the bare battery cell and the battery cell.

It is to be noted that in the embodiment of the present disclosure, in the process of manufacturing the composite pole piece 10, some other steps are included, for example, a necessary operation such as tab processing and cutting, which is not repeated in the embodiment.

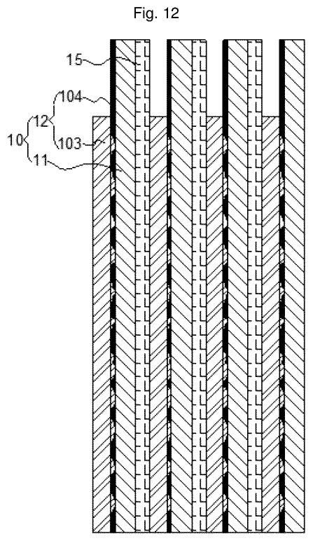

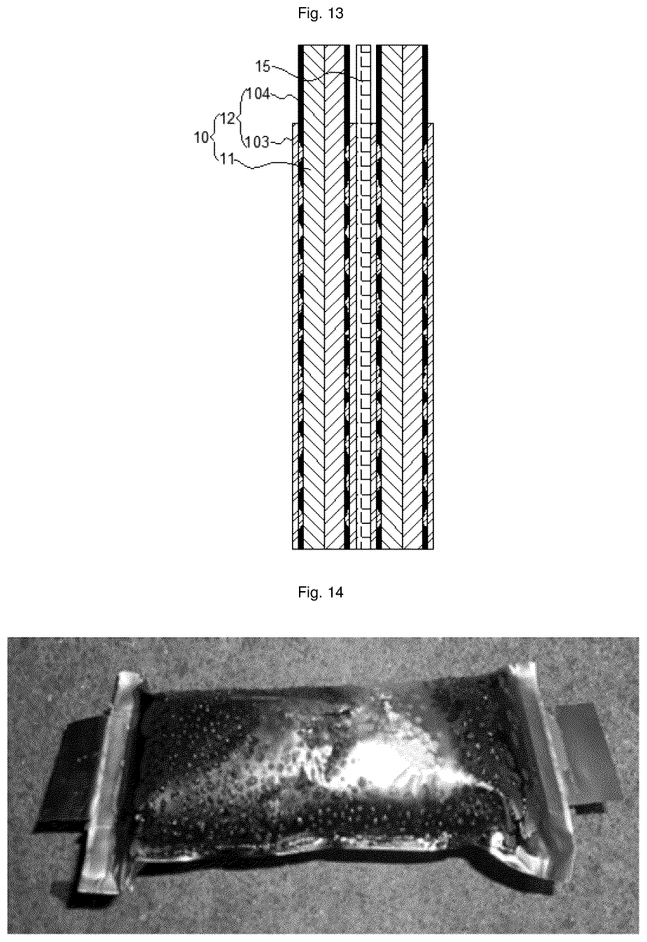

FIG. 11 is a schematic structural diagram of a first type of bare battery cell according to the embodiment. FIG. 12 is a schematic structural diagram of a second type of bare battery cell according to the embodiment. FIG. 13 is a schematic structural diagram of a third type of bare battery cell according to the embodiment. Based on the structure of the composite pole piece 10, the embodiment of the present disclosure also provides a battery cell, which includes three types of bare battery cell structures. All the three type of bare battery cells is formed by lamination and also is formed by winding, and at least one of the positive pole piece and the negative pole piece of the three types of bare battery cells is the composite pole piece 10. The embodiment takes both the positive pole piece and the negative pole piece being the composite pole piece 10 as an example to introduce the structures of the three types of bare battery cells in detail.

In the first type of bare battery cell, both the positive and negative pole pieces are composite pole pieces 10, the thicknesses of the active composite layers 12 of the positive and negative pole pieces are both 0.05 um-6 um, and the thickness of the supporting layer 11 is set to be 2 um-20 um, so that the thicknesses of the active composite layers 12 of the positive and negative pole pieces are both smaller than the thickness of the corresponding supporting layer 11. At this time, the insulating layers 101 of the positive and negative pole pieces themselves are used as isolation layers. At this time, the materials of the insulating layers 101 of the positive and negative pole pieces are selected to be the material of a usual isolation layer of the battery cell, and for example, may be selected to be a PE layer, a PP layer or a PP/PE/PP composite layer. The positive pole piece and the negative pole piece are sequentially stacked as shown in FIG. 11 to form the bare battery cell, and the active composite layer 12 of one of the positive pole piece and the negative pole piece is attached to the side, away from the conductive layer 102, of the insulating layer 101 of the other. Through such an arrangement, there is no need to set an additional isolation layer, which is able to save the costs. Meanwhile, at this time, the thickness of the active composite layer 12 is smaller than the thickness of the supporting layer 11, so that the active composite layer 12 is not prone to piercing the supporting layer 11, which is able to reduce the occurrence probability of an internal short circuit problem and improve the safety performance of the composite pole piece 10.

Of course, in other embodiments, the thickness of the active composite layer 12 and the thickness of the supporting layer 11 both are adjusted as required, so that the thickness of the active composite layer 12 is less than the thickness of the supporting layer 11 in the solution of the first type of bare battery cell, which is not limited in the embodiment.

In the second type of bare battery cell, the thicknesses of the active composite layers 2 of the positive pole piece and the negative pole piece are both greater than or equal to the thickness of the corresponding supporting layer 11. At this time, the active composite layer 12 is in danger of piercing the supporting layer 11, so the bare battery cell also includes an isolation film 15 arranged between the positive pole piece and the negative pole piece. The isolation film 15 is a conventional cell isolation film 15, which may be selected to be a PE layer, a PP layer or a PP/PE/PP composite layer with a thickness of 7 um or 9 um. At this time, the positive pole piece, the isolation film 15 and the negative pole piece are sequentially stacked as shown in FIG. 12 to form the bare battery cell. In the second type of bare battery cell, due to the existence of the isolation film 15, the material and thickness of the insulating layer 101 in the supporting layer 11 may not be limited, and any material that is able to provide insulating support is selected. For example, an organic polymer material or a ceramic-doped polymer is selected.

In the third type of bare battery cell, the positive pole piece includes two composite pole pieces 10, and the sides, away from the active composite layer 12, of the two supporting layers 11 of the two composite pole pieces 10 are attached to each other. The negative pole piece includes two composite pole pieces 10, and the sides, away from the active composite layer 12, of the two supporting layers 11 of the two composite pole pieces 10 are attached to each other. Through such an arrangement, both the positive and negative pole pieces are secondary composite pole pieces. At this time, the bare battery cell is provided with the isolation film 15 according to requirements. The isolation film 15 is selected to be the PE layer, the PP layer or the PP/PE/PP composite layer with a thickness of 7 um or 9 um. The positive pole piece, the isolation film 15 and the negative pole piece are sequentially stacked as shown in FIG. 13 to form the bare battery cell. Moreover, due to the existence of the isolation film 15, the material and thickness of the insulating layer 101 in the supporting layer 11 may not be limited, and any material that is able to provide insulating support is selected. For example, an organic polymer material or a ceramic-doped polymer is selected.

On the basis of the above three types of bare battery cells, the battery cell provided by the embodiment of the present disclosure further includes a shell and an electrolyte. The shell is provided with a positive column and a negative column. The bare battery core and the electrolyte are arranged in the shell, the positive pole piece is electrically connected with the positive column through a positive tab, and the negative pole piece is electrically connected with the negative column through a negative tab.

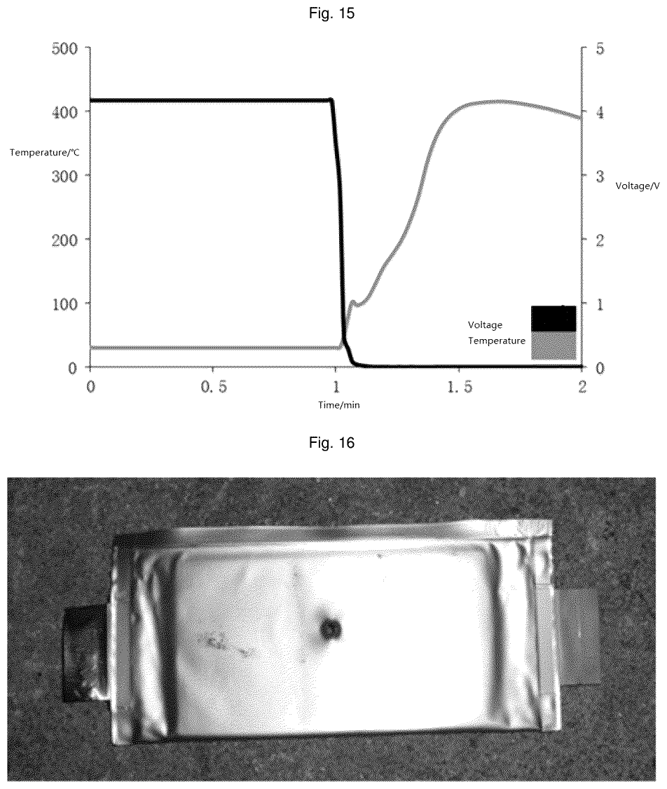

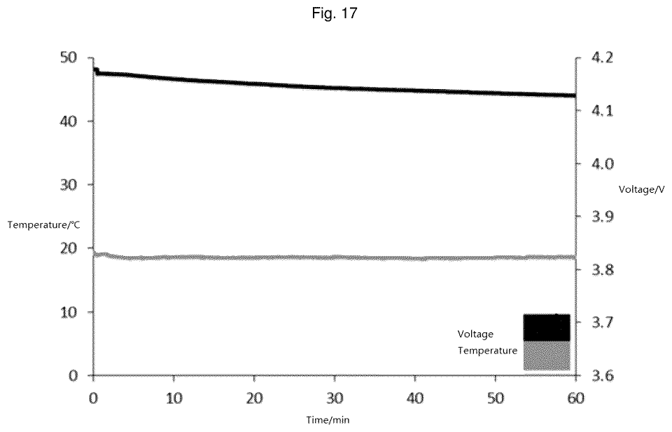

FIG. 14 is a schematic diagram of a nail threading test on the battery cell according to the related art. FIG. 15 is a result diagram of a nail threading test on the battery cell according to the related art. FIG. 16 is a schematic diagram of a nail threading test of the battery cell formed after housing the first type of bare battery cell according to the embodiment. FIG. 17 is a result diagram of a nail threading test of the battery cell formed after housing the first type of bare battery cell according to the embodiment. Referring to FIGS. 14 to 17, in order to prove that the battery cell prepared by the composite pole piece 10 provided by the embodiment of the present disclosure has better safety performance, the battery cell obtained after the first type of bare battery cell is housed in the embodiment and the battery cell in the related art are subjected to the nail threading test under the same parameter conditions. The parameters of the battery cell in the related art are shown in Table 2, and the parameters of the battery cell in the embodiment are shown in Table 3. The nail threading test is performed according to a flow path in the national standard GBT31485, and a test condition is as follows: at 25±5° C., with full charge to 4.2V, a 3 mm steel needle pierces into a battery cell explosion-proof valve (with a clamp) at a speed of 25 mm/s. Experimental results are shown in FIG. 16 and FIG. 17, respectively.

TABLE 2
Parameters of Battery Cell in the Related Art

| Positive pole piece current collector material | Aluminum (Al) | |
|---|---|---|
| Positive pole piece current collector thickness | 13 | um |
| Positive pole piece active layer material | Lithium nickel | |
| | cobalt manganate | |
| Positive pole piece active layer thickness | 120 | um |
| Isolation film material | PE | |
| Isolation film thickness | 9 | um |
| Negative pole piece current collector material | Copper (Cu) | |
| Negative pole piece current collector thickness | 6 | um |
| Negative pole piece active layer material | Graphite | |
| Negative pole piece active layer thickness | 140 | um |

TABLE 3
Parameters of Battery Cell in the Embodiment

| | |
|---|---|
| Positive pole piece insulating layer material | PE |
| Positive pole piece insulating layer thickness | 7 um |
| Positive pole piece conductive layer material | Graphene |
| Positive pole piece conductive layer thickness | 5 nm |
| Positive pole piece active layer material | Lithium nickel |
| | cobalt manganate |
| Positive pole piece active layer thickness | 5 um |
| Positive pole piece metal foil layer thickness | 1 um |
| Negative pole piece insulating layer material | PE |
| Negative pole piece insulating layer thickness | 7 um |
| Negative pole piece conductive layer material | Graphene |
| Negative pole piece conductive layer thickness | 5 nm |
| Negative pole piece active layer material | Graphite |
| Negative pole piece active layer thickness | 5 um |
| Negative pole piece metal foil layer thickness | 1 um |

According to records in Tables 2 and 3 and FIGS. 14 to 17, it is to be seen that the temperature of the pierced battery cell in the related art rises rapidly, the voltage of the battery cell drops sharply, and the battery cell swells and fails. However, the battery voltage of the pierced battery cell with the composite pole piece 10 provided by the embodiment is slightly reduced, the battery temperature does not change obviously, and the battery has no failure situation such as swelling after nailing, which proves that the safety performance of the battery cell with the composite pole piece 10 provided by the embodiment is relatively high.

Detailed introduction is made below to the preparation process and beneficial effects of the battery cell provided by the embodiment of the present disclosure.

When the battery cell is prepared, the positive pole piece and the negative pole piece are prepared respectively, both of the positive pole piece and the negative pole piece are composite pole pieces 10 as shown in FIG. 2, and the thicknesses of the active composite layers 12 of the positive pole piece and the negative pole piece are both smaller than the thickness of the corresponding supporting layer 11. Then, the positive pole piece and the negative pole piece are stacked as shown in FIG. 11 to form the bare battery cell, and finally, the bare battery cell is housed and injected with liquid to form the battery cell. In the process of preparing the composite pole piece 10, as shown in FIG. 3, the conductive layer 102 is formed by spraying on the insulating layer 101, then the supporting layer 11 provided with the conductive layer 102 is put into the colloid solution 115 for electrophoretic deposition to form the active layer 103 on a side of the conductive layer 102 away from the insulating layer 101, the supporting layer 11 provided with the active layer 103 is put into the ionic solution 117 for the electrodeposition operation to form the metal foil layer 104 by deposition on the surface of the conductive layer 102, and the plurality of active particles 106 are fixed to the conductive layer 102 during deposition; and finally, rolling and the processing operation of the battery tab are performed.

In the above process, on the one hand, the conductive layer 102 is arranged, and the plurality of active particles 106 in the active layer 103 are stacked on the conductive layer 102 using the characteristic of active electric conductivity of the electrons near the conductive layer 102, so that the metal ions 113 is able to pass through gaps of the active particles 106 and be deposited on the conductive layer 102 to form the metal foil layer 104, and the performance and quality of the composite pole piece 10 are guaranteed. On the other hand, the metal foil layer 104 is able to fix the active particles 106 in the active layer 103 on the conductive layer 102 during deposition, which eliminates the use of adhesive during preparation and effectively reduce the production cost of the composite pole piece 10.

In conclusion, the embodiment of the present disclosure provides the composite pole piece 10 which fixes the active particles 106 in the active layer 103 on the conductive layer 102 through the metal foil layer 104, which is able to eliminate the use of adhesive and effectively reduce the production cost of the composite pole piece 10 while ensuring the performance of the pole piece. The embodiment of the present disclosure further provides the bare battery cell and the battery cell, which include the composite pole piece 10 above. Therefore, the costs are reduced while the performance is ensured. The embodiment of the present disclosure further provides the preparation method of the composite pole piece 10. During preparation, the composite pole piece 10 fixes the active particles 106 in the active layer 103 on the conductive layer 102 through the metal foil layer 104, which is able to eliminate the use of adhesive and effectively reduce the production cost of the composite pole piece 10 while ensuring the performance of the pole piece.

The above is only the specific implementation mode of the present disclosure and is not intended to limit the scope of protection of the present disclosure. Any variations or replacements apparent to those skilled in the art within the technical scope disclosed by the present disclosure shall fall within the scope of protection of the present disclosure. Therefore, the scope of protection of the present disclosure shall be subjected to the scope of protection of the claims.

What is claimed is:

1. A composite pole piece, comprising:
a supporting layer, comprising an insulating layer and a conductive layer arranged on a side of the insulating layer; and
an active composite layer, arranged on a side of the conductive layer away from the insulating layer and comprising an active layer and a metal foil layer, wherein the active layer comprises a plurality of active particles stacked on the conductive layer, and the metal foil layer is attached to the conductive layer, and configured to fix the plurality of active particles on the conductive layer during deposition.

2. The composite pole piece according to claim 1, wherein
a projection plane of the metal foil layer on the conductive layer in a direction perpendicular to the conductive layer is a first projection plane, and a projection plane of the active layer on the conductive layer in the direction perpendicular to the conductive layer is a second projection plane; and
an area of the first projection plane is larger than an area of the second projection plane, and the second projection plane falls within a range of the first projection plane.

3. The composite pole piece according to claim 1, wherein
in a width direction of the conductive layer, two sides of the metal foil layer are aligned with two sides of the conductive layer, and two sides of the active layer are aligned with the two sides of the conductive layer, wherein in a length direction of the conductive layer, one end of two ends of the metal foil layer is aligned with a corresponding end of the conductive layer, the other end of the two ends of the metal foil layer is at a first preset distance from the other corresponding end of the conductive layer, one end of two ends of the active layer is aligned with the corresponding end of the conductive layer, and the other end of the two ends of the active layer is at a second preset distance from the corresponding end of the conductive layer;
or,
in the length direction of the conductive layer, the two ends of the metal foil layer are aligned with the two ends of the conductive layer, and the two ends of the active layer are aligned with the two ends of the conductive layer, wherein in the width direction of the conductive layer, a side of the two sides of the metal foil layer is aligned with a corresponding side of the conductive layer, the other side of the two sides of the metal foil layer is at the first preset distance from the other corresponding side of the conductive layer, one end of the two sides of the active layer is aligned with the corresponding side of the conductive layer, and the other side of the two sides of the active layer is at the second preset distance from the corresponding side of the conductive layer.

4. The composite pole piece according to claim 3, wherein
the first preset distance is 0-1 mm; and/or the second preset distance is 5 mm-100 mm.

5. The composite pole piece according to claim 1, wherein
a thickness of the supporting layer is 2 um-20 um;
and/or,
a thickness of the metal foil layer is 0.05 um-6 um;
and/or,
a thickness of the conductive layer is 1 nm-10 nm;
and/or,
the conductive layer comprises a metal layer or a graphite layer.

6. The composite pole piece according to claim 1, wherein
a material of the insulating layer is an organic polymer material or a ceramic-doped polymer;
or,
the insulating layer is a polyethylene layer, a polypropylene layer or a PP/PE/PP composite layer.

7. The composite pole piece according to claim 1, wherein
when the composite pole piece is a positive pole piece, the metal foil layer is a metal aluminum layer, and an active component in the active particles is lithium cobalt oxide, lithium iron phosphate, lithium manganate or lithium nickel cobalt manganate; and
when the composite pole piece is a negative pole piece, the metal foil layer is a metal copper layer, and the active component in the active particles is graphite, hard carbon, soft carbon, lithium titanate or silicon carbon.

8. The composite pole piece according to claim 1, wherein
a side of the active layer away from the conductive layer is provided with an active plane.

9. A battery cell, comprising:
a positive pole piece and a negative pole piece, wherein at least one of the positive pole piece and the negative pole piece comprises the composite pole piece according to claim 1.

10. The battery cell according to claim 9, wherein
the positive pole piece and the negative pole piece are both the composite pole pieces;
when thicknesses of the active composite layers of the positive pole piece and the negative pole piece are both less than a thickness of a corresponding supporting layer, the insulating layers of the positive pole piece and the negative pole piece are PE layers, PP layers or PP/PE/PP composite layers; the positive pole piece and the negative pole piece are sequentially stacked to form a bare battery cell, and the active composite layer of one of the positive pole piece and the negative pole piece is attached to the side, away from the conductive layer, of the insulating layer of the other; and
when the thicknesses of the active composite layers of the positive pole piece and the negative pole piece are both greater than or equal to the thickness of the corresponding supporting layer, the bare battery cell further comprises an isolation film arranged between the positive pole piece and the negative pole piece; the positive pole piece, the isolation film and the negative pole piece are sequentially stacked to form a bare battery cell; and the battery cell also comprises a shell and an electrolyte, and the bare battery cell and the electrolyte are accommodated in the shell.

11. The battery cell according to claim 9, wherein
the positive pole piece comprises two composite pole pieces, and the sides, away from the active composite layer, of the two supporting layers of the two composite pole pieces are attached to each other; the negative pole piece comprises two composite pole pieces, and the sides, away from the active composite layer, of the two supporting layers of the two composite pole pieces are attached to each other;
the bare battery cell further comprises an isolation film, and the positive pole piece, the isolation film and the negative pole piece are sequentially stacked to form the bare battery cell; and the battery cell also comprises a shell and an electrolyte, and the bare battery cell and the electrolyte are accommodated in the shell.

12. A preparation method of the composite pole piece according to claim 1, comprising:
stacking a plurality of active particles on the conductive layer to form an active layer; and
depositing metal ions on a surface of the conductive layer from a side of the conductive layer close to the active layer to form the metal foil layer, and fixing the plurality of active particles on the conductive layer during deposition;
the step of stacking the plurality of active particles on the conductive layer to form the active layer specifically comprises:
placing the supporting layer in a colloidal solution containing the plurality of active particles for electrophoretic deposition, and depositing the plurality of colloidal active particles on a side of the conductive layer away from the insulating layer to form the active layer.

13. The preparation method of the composite pole piece according to claim 12, wherein the step of electrophoretic deposition specifically comprises:
attaching a side of the insulating layer away from the conductive layer to a first electrode plate and then putting same into the colloidal solution;
putting a second electrode plate with a polarity opposite to that of the first electrode plate into the colloidal solution and arranging same at an interval from the first electrode plate; and
electrifying the first electrode plate and the second electrode plate.

14. The preparation method of the composite pole piece according to claim 13, wherein
a distance that a circumferential direction of the first electrode plate exceeds a circumferential direction of the insulating layer is 5 mm-100 mm;
and/or,
an area of each of the first electrode plate and the second electrode plate is 0.001 m²-200 m²;
and/or,
a distance between the first electrode plate and the second electrode plate is 5 mm-5 m;
and/or,
the colloidal solution has a pH of 7-10;
and/or,
after the insulating layer is put into the colloidal solution, the insulating layer exceeds a liquid level of the colloidal solution by 5 mm-100 mm.

15. The preparation method of the composite pole piece according to claim 13, before placing the supporting layer in the colloidal solution, further comprising:
dispersing the active particles in an organic solvent, and stirring same to obtain the colloidal solution containing the colloidal active particles;
in the process of stirring to obtain the colloidal solution, a stirring speed is 5 rmp-2000 rpm, and a stirring time is 30 min-300 min.

16. The preparation method of the composite pole piece according to claim 12, wherein the step of depositing the metal ions on the surface of the conductive layer from the side of the conductive layer close to the active layer to form the metal foil layer specifically comprises:
placing the supporting layer with the active particles stacked in an ionic solution containing the metal ions for electrodeposition, so as to form the metal foil layer by deposition on the surface of the conductive layer, wherein
when the composite pole piece is a negative pole piece, the ionic solution is a copper ionic solution, and a concentration of the copper ionic solution is 0.001 mol/L-0.1 mol/L; and when the composite pole piece is a positive pole piece, the ionic solution is an aluminum ionic solution, and a concentration of the aluminum ionic solution is 0.001 mol/L-0.1 mol/L.

17. The preparation method of the composite pole piece according to claim 16, wherein in the electrodeposition step, a deposition thickness of the metal foil layer is 0.05 um-6 um, and the deposition thickness of the metal foil layer is adjusted according to the following rules:
when a deposition temperature is 45° C., a deposition current is 100 A, a concentration of the ionic solution is 0.01 mol/L, a deposition time is 2 min, and a deposition area is 50 mm×100 mm, a deposition thickness is 23.1 um;
when the deposition temperature is 45° C., the deposition current is 100 A, the concentration of the ionic solution is 0.01 mol/L, the deposition time is 1 min, and the deposition area is 50 mm×50 mm, the deposition thickness is 22.8 um;
when the deposition temperature is 45° C., the deposition current is 50 A, the concentration of the ionic solution is 0.02 mol/L, the deposition time is 1 min, and the deposition area is 50 mm×100 mm, the deposition thickness is 20.7 um;
when the deposition temperature is 45° C., the deposition current is 100 A, the concentration of the ionic solution is 0.01 mol/L, the deposition time is 1 min, and the deposition area is 50 mm×100 mm, the deposition thickness is 12.7 um;
when the deposition temperature is 35° C., the deposition current is 100 A, the concentration of the ionic solution is 0.01 mol/L, the deposition time is 1 min, and the deposition area is 50 mm×100 mm, the deposition thickness is 11.3 um;
when the deposition temperature is 45° C., the deposition current is 100 A, the concentration of the ionic solution is 0.01 mol/L, the deposition time is 1 min, and the deposition area is 50 mm×100 mm, the deposition thickness is 6.5 um;
when the deposition temperature is 45° C., the deposition current is 30 A, the concentration of the ionic solution is 0.01 mol/L, the deposition time is 1 min, and the deposition area is 50 mm×100 mm, the deposition thickness is 4.8 um;
when the deposition temperature is 45° C., the deposition current is 25 A, the concentration of the ionic solution is 0.02 mol/L, the deposition time is 1 min, and the deposition area is 50 mm×100 mm, the deposition thickness is 4.1 um; and
when the deposition temperature is 45° C., the deposition current is 20 A, the concentration of the ionic solution is 0.01 mol/L, the deposition time is 1 min, and the deposition area is 50 mm×100 mm, the deposition thickness is 3.2 um.

18. The preparation method of the composite pole piece according to claim 16, wherein in the electrodeposition step,
the insulating layer exceeds a liquid level of the ionic solution by 0-1 mm.

19. The preparation method of the composite pole piece according to claim 12,
before stacking the plurality of active particles on the conductive layer, further comprising coating or depositing a conductive substance on a side of the insulating layer to form the conductive layer on the insulating layer.

20. The preparation method of the composite pole piece according to claim 12,
after forming the metal foil layer by deposition on the surface of the conductive layer, further comprising performing rolling operation to enable the active layer to press against the conductive layer and enable a side of the active layer away from the conductive layer to form an active plane, a rolling pressure of the rolling operation is 5 T-500 T, and a rolling temperature is 50° C.-90° C.
